(19) United States
(12) Patent Application Publication
(10) Pub. No.: US 2006/0289443 A1
(43) Pub. Date: Dec. 28, 2006

(54) Household electric heating cooker with detachable power outlet

(76) Inventor: Dong-lei Wang, Zhuhai City (CN)

Correspondence Address: CARSTENS & CAHOON, LLP, P O BOX 802334, DALLAS, TX, 75380, US

(21) Appl. No.: 11/126,679

(22) Filed: May 11, 2005

(51) Int. Cl. F27D 11/00

(52) U.S. Cl. 219/430

(57) ABSTRACT

This invention provides a kind of household electric heating cooker with detachable power outlet. The cooker has a control box detachably attached at the front of its shell, wherein the control box comprises electric heating elements and control elements. By means of the detachable power outlet, the power cord is connected from the side opposite to the control box of the cooker. Moreover, both of the detachable power outlet and the control box can be separated from the shell, thereby, it is more convenient and safe when cleaning the cooking bowl and the shell, and the appearance of the cooker becomes more beautiful.

### TECHNICAL FIELD

This invention relates to a kind of household electric heating cooker, such as deep fryers, electric rice cookers, electric slow cookers, etc, and more particularly, to a kind of household electric heating cooker with detachable power outlet.

### BACKGROUND OF THE INVENTION

An existing household electric cooker, such as a deep fryer, usually comprises a cooking bowl, a top cover, a control box consisted of electric heating and controlling elements, a power cord and a shell. The shell is usually made of plastic, for easy cleaning of the cooking bowl. Generally, the cooking bowl and the shell can be separated, however, the shell still can not be cleaned. Since the control box is normally installed in the front of the shell, while the power cord must be connected from the rear bottom part of the shell, the connecting device between the control box and the power cord is fixed on the shell, hence the control box is also fixed on the shell. In order to ensure the safety of the electronic elements, and to avoid contact of detergent and water with the control box, the shell cannot be cleaned at will. If a detachable power cord is added, i.e. to connect the power cord to the front bottom part of the shell, it will affect not only the appearance of the cooker, but also safety of the operator.

### SUMMARY OF THE INVENTION

The objective of this invention is to provide a kind of household electric heating cooker with detachable power outlet. By means of said detachable power outlet, the power cord is connected from the side opposite to the control box. Moreover, both of the detachable power outlet and the control box can be separated from the shell, thereby, it is more convenient and safe when cleaning the cooking bowl and the shell, and the appearance of the cooker becomes more beautiful.

The technical scheme of the present invention is as follows:

A household electric heating cooker with a detachable power outlet, comprising:
a shell;
a cooking bowl set inside said shell;
a top cover set on top of said cooking bowl;
a control box detachably attached at the front of said shell; said control box comprises electric heating elements and control elements;
a power cord;
an elongated power connecting component, by means of which, the input terminals of said control box is electrically connected to said power cord;
wherein on the bottom of said shell, is carved a groove extending from under the control box at the front of the shell to the rear of the shell; said power outlet can be contained within said groove and be taken out from the rear of the shell.

The shape of the rear end of the power connecting component is designed to fit with the edge of said groove on the outer surface of the shell when the power connecting component is installed in position.

Said power connecting component has a detachable outlet fixed on the top of its front end, a chamber in the middle, and a power connector at its rear end. Said power connector is suitable to be electrically connected with said power cord. Said detachable outlet has contact points installed inside. When said power connecting component is installed in position, said contact points are electrically connected to the power input of the control box at one end, and said contact points are electrically connected to the power connector at the rear end of the power connecting component via connecting cords at the other end.

Thanks to the design of this invention, the power cord can be connected from the side opposite to the control box, and both of the power connecting component and the control box can be detached. When the electric cooker needs to be cleaned, the major components can be taken apart in sequence. Since the shell has no electric parts, it can be cleaned safely, without worrying about electric leakage caused by electric elements, and the appearance of the cooker is not affected either. The shell can be made of plastic or metal materials based on needs. This invention is safe for use, cost cheaply and can be applied to various detachable household electric heating cookers comprising a cooking bowl and a shell.

### BRIEF DESCRIPTION OF THE DRAWINGS

FIG. 1 is a sectional view of an embodiment of the electric heating cooker according to this invention;

FIG. 2 is an explosive view of the electric heating cooker shown in FIG. 1;

FIG. 3 is a schematic view of the power connecting component of the electric heating cooker shown in FIG. 1.

### DETAILED DESCRIPTION OF THE PREFERRED EMBODIMENTS

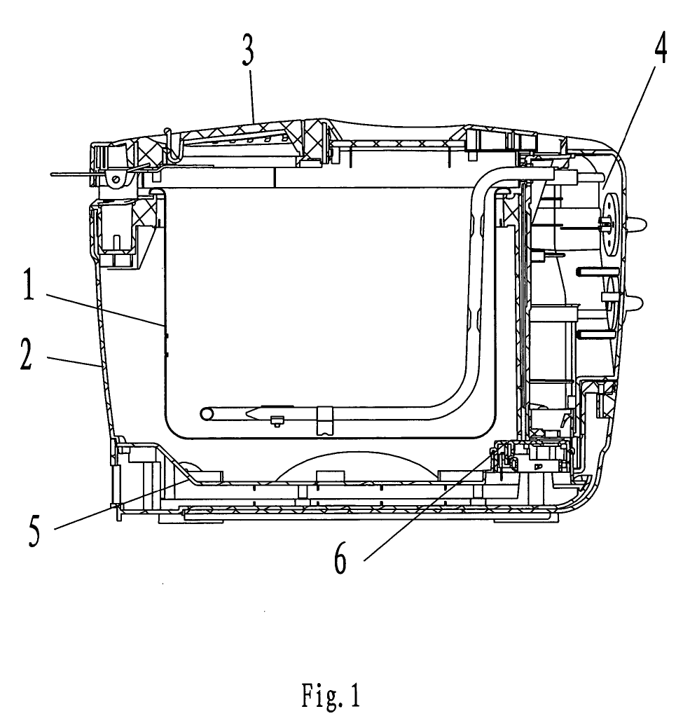

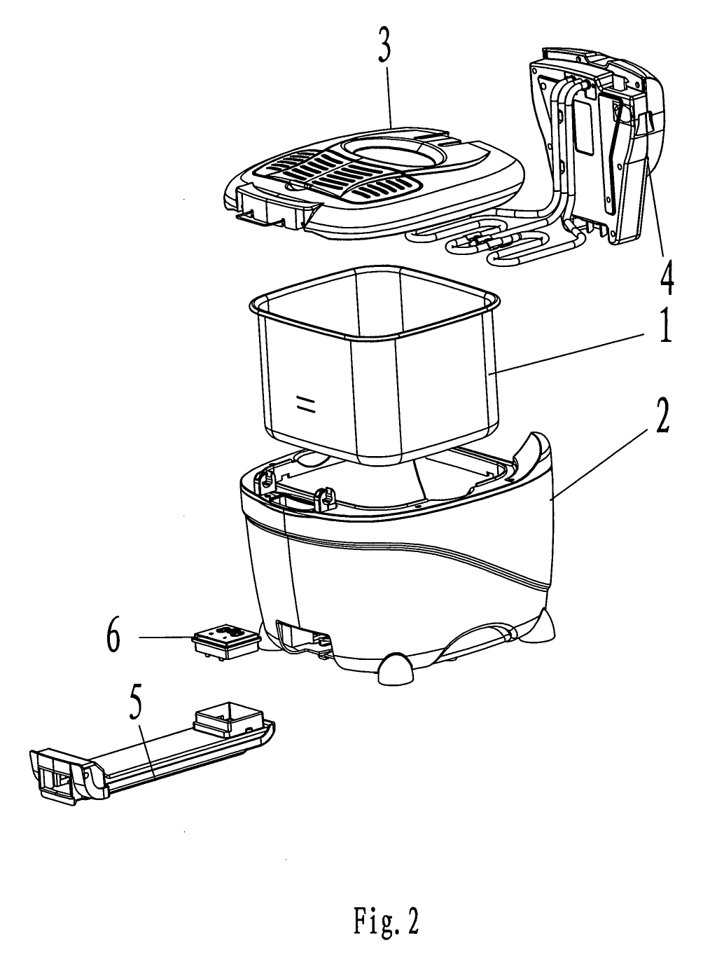

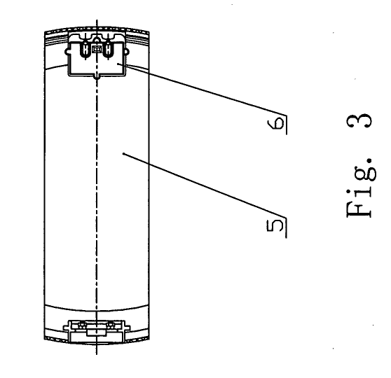

As shown in FIG. 1, FIG. 2 and FIG. 3, a household electric heating cooker with a detachable power outlet comprises a shell 2, a cooking bowl 1, a top cover 3, a control box 4, a power connecting component 5 and a power cord (not shown).

The cooking bowl 1, which is set inside the shell 2, is for accommodating food when cooking.

The shell 2 is the support for the cooking bowl, and may be the support for the top cover 3 as well, which constitutes the frame of the whole cooker.

The top cover 3 is set on top of the cooking bowl 1.

In this embodiment, the electric heating elements and the control elements are integrally designed into a control box 4, comprising a power switch, a temperature controller, an overheating protection device, electric heating tubes, power pinouts, etc., wherein the heating portion of the electric heating tubes is located at the bottom inside the cooking bowl when the electric cooker is assembled, and said control box 4 is detachablely attached to the front of the shell 2.

The power connecting component 5 is elongated, by means of which, input terminals of the control box 4 are electrically connected to the power cord.

On the bottom of said shell 2, is carved a groove extending from under the control box 4 in the front of the shell to the rear of the shell. Said power outlet 5 can be contained within said groove and be taken out from the rear of the shell 2.

The shape of the rear end of the power connecting component 5 is designed to fit with the edge of said groove on the outer surface of the shell 2 when the power connecting component 5 is installed in position.

The power connecting component 5 has a detachable outlet 6 fixed on the top of its front end, a chamber in the middle, and a power connector at its rear end. Said power connector is suitable to be electrically connected with said power cord.

Said detachable outlet 6 for power input to the control box 4 has contact points installed inside. When both of the control box 4 and the power connecting component 5 are installed on the shell 2, said contact points are electrically connected to the power input of the control box 4 at one end, and said contact points are electrically connected to the power connector at the rear end of the power connecting component 5 via connecting cords at the other end.

In this embodiment, various components are assembled according to following sequence: the cooking bowl 1 is set directly inside the shell 2 from the top; the power connecting component 5 is inserted in from the rear bottom of the shell 2; the control box 4 is clapped in the front of the shell 2, making the heating portion of the electric heating tubes at the bottom inside the cooking bowl 1, and the attached power pinouts of the control box 4 are contacted with the contact points of the detachable outlet 6 on the power connecting component 5. The control box 4 should be installed after the cooking bowl 1 and the power connecting component 5 has been installed into the shell 2, and after the control box 4 is installed inside the shell 2, the cooking bowl 1 and the power connecting component 5 cannot be detached. Assembling in other kinds of sequences is also possible.

When the electronic cooker is in use, power cord is inserted into the power connector of the power connecting component 5, and via the contact points of the detachable outlet 6 of the power connecting component 5 and the power pinouts of the control box 4, power is connected to the switch or temperature controller of the control box 4, hence the working status of the electric heated cooker is controlled by adjusting the switch or the temperature controller of the control box 4.

After the control box 4 is fit into the shell 2, the heating portion of the attached electric heating tubes is just at the bottom inside the cooking bowl 2, and the attached power pinouts contact with the contacting points of the detachable outlet of the power connecting component 5.

When cleaning is needed, the major components can be detached sequentially. Since the shell 2 is separated from the power connecting component 5, and the shell 2 does not have any electric parts, the cooker can be cleaned without worrying about safety accidents such as electricity leakage caused by electric elements, and the appearance of the cooker is not affected either.

1. A household electric heating cooker with a detachable power outlet, comprising:
a shell;
a cooking bowl set inside said shell;
a top cover set on top of said cooking bowl;
a control box detachably attached at the front of said shell; said control box comprises electric heating elements and control elements;
a power cord;
an elongated power connecting component, by means of which, the input terminals of said control box is electrically connected to said power cord;
wherein on the bottom of said shell, is carved a groove extending from under the control box at the front of the shell to the rear of the shell; said power outlet can be contained within said groove and be taken from the rear of the shell.

2. A household electric heating cooker with detachable power outlet according to claim 1, wherein the shape of the rear end of the power connecting component is designed to fit with the edge of said groove on the outer surface of the shell when the power connecting component is installed in position.

3. A household electric heating cooker with detachable power outlet according to claim 1, wherein said power connecting component has a detachable outlet fixed on the top of its front end, a chamber in the middle, and a power connector at its rear end; said power connector is suitable to be electrically connected with said power cord; said detachable outlet has contact points installed inside; when said power connecting component is installed in position, said contact points are electrically connected to the power input of the control box at one end, and said contact points are electrically connected to the power connector at the rear end of the power connecting component via connecting cords at the other end.

4. A household electric heating cooker with detachable power outlet according to claim 2, wherein said power connecting component has a detachable outlet fixed on the top of its front end, a chamber in the middle, and a power connector at its rear end; said power connector is suitable to be electrically connected with said power cord; said detachable outlet has contact points installed inside; when said power connecting component is installed in position, said contact points are electrically connected to the power input of the control box at one end, and said contact points are electrically connected to the power connector at the rear end of the power connecting component via connecting cords at the other end.

5. A household electric heating cooker with detachable power outlet according to claim 1, wherein when the control box is set inside the shell, the heating portion of said electric heating elements is located at the bottom inside said cooking bowl.

6. A household electric heating cooker with detachable power outlet according to claim 1, wherein said control box comprises a power switch, a temperature controller, an overheating protection device, electric heating tubes and power pinouts.

7. A household electric heating cooker with detachable power outlet according to claim 6, wherein after the control box is fit into the shell, its power pinouts contact with the contact points of the detachable outlet of said power connecting component.
